(19) United States
(12) Patent Application Publication
(10) Pub. No.: US 2016/0347151 A1
(43) Pub. Date: Dec. 1, 2016

(54) OPERATION INPUT DEVICE AND AIR-CONDITIONING DEVICE USING SAME

(71) Applicant: KABUSHIKI KAISHA TOKAI RIKA DENKI SEISAKUSHO, Aich (JP)

(72) Inventors: Shuri ARAKAWA, Aichi (JP); Yuki HARAZAWA, Aichi (JP)

(21) Appl. No.: 15/116,755

(22) PCT Filed: Jan. 26, 2015
(86) PCT No.: PCT/JP2015/052047

§ 371 Date: Aug. 4, 2016

(30) Foreign Application Priority Data
Feb. 17, 2014 (JP) 2014-027301

(51) Int. Cl. B60H 1/00; B60K 37/06

(52) U.S. Cl. CPC B60H 1/00985; B60H 1/0065; B60K 37/06

(57) ABSTRACT

An operation input device includes an operation detection unit that detects an operation that has been made, the operation detection unit having a plurality of operation regions to which, of functions executed by a controlled device, a same type of functions are assigned, and a controller that determines one of the plurality of operation regions in which an operation has been detected by the operation detection unit to be a master operation region and the other of the operation regions to be a slave operation region, and outputs, to the controlled device, control information for controlling such that a state of the function assigned to the slave operation region is matched to a state of the function assigned to the master operation region

### TECHNICAL FIELD

The present invention relates to an operation input device and an air conditioning device that uses the operation input device.

### BACKGROUND ART

An operation panel for an automobile air conditioning device, including a display part that selectively displays an air conditioning control state of a driver's seat side air conditioning zone or a passenger's seat side air conditioning zone in a vehicle, a driver's seat side temperature setting switch that enables a temperature to be set for the driver's seat side air conditioning zone, and a passenger's seat side temperature setting switch that enables a temperature to be set for the passenger's seat side air conditioning zone, is known (see PTL 1, for example).

This operation panel for an automobile air conditioning device can set a set temperature for the driver's seat side air conditioning zone in response to the driver's seat side temperature setting switch being operated, and can set a set temperature for the passenger's seat side air conditioning zone in response to the passenger's seat side temperature setting switch being operated.

### CITATION LIST

### Patent Literature

[PTL 1]

JP-A-H08-318729

### SUMMARY OF INVENTION

### Technical Problem

With the operation panel for an automobile air conditioning device disclosed in PTL 1, when an operator sets the set temperature for the driver's seat side air conditioning zone and the set temperature for the passenger's seat side air conditioning zone to the same set temperature, it is necessary for the operator to adjust the set temperatures for both zones in order so that the desired temperatures are set, resulting in poor operability.

Thus, an object of the present invention is to provide an operation input device with improved operability and an air conditioning device using the operation input device.

### Solution to Problem

According to an embodiment of the invention, an operation input device is provided that comprises an operation detection unit that detects an operation that has been made, the operation detection unit having a plurality of operation regions to which, of functions executed by a controlled device, the same type of functions are assigned, and a controller that determines one of the plurality of operation regions in which an operation has been detected by the operation detection unit to be a master operation region and the other of the operation regions to be a slave operation region, and outputs, to the controlled device, control information for controlling such that a state of the function assigned to the slave operation region is matched to a state of the function assigned to the master operation region.

### Advantageous Effects of Invention

According to an embodiment of the invention, an operation input device with improved operability and an air conditioning device using the operation input device are provided.

### BRIEF DESCRIPTION OF DRAWINGS

[FIG. 1A]

FIG. 1A is a schematic diagram illustrating the interior of a vehicle in which a touch panel according to a first embodiment is installed.

[FIG. 1B]

FIG. 1B is an exploded perspective view of the touch panel.

[FIG. 1C]

FIG. 1C is a schematic diagram illustrating the touch panel, viewed from an operating surface side thereof.

[FIG. 2A]

FIG. 2A. is a block diagram illustrating the touch panel according to the first embodiment.

[FIG. 2B]

FIG. 2B is a block diagram illustrating a vehicle communication system to which the touch panel is electromagnetically connected.

[FIG. 3A]

FIG. 3A is a schematic diagram illustrating a first example of adjusting a set temperature with the touch panel according to the first embodiment.

[FIG. 3B]

FIG. 3B is a schematic diagram illustrating the first example of adjusting a set temperature with the touch panel according to the first embodiment.

[FIG. 3C]

FIG. 3C is a schematic diagram illustrating the first example of adjusting a set temperature with the touch panel according to the first embodiment.

[FIG. 4A]

FIG. 4A is a schematic diagram illustrating a second example of adjusting a set temperature with the touch panel according to the first embodiment.

[FIG. 4B]

FIG. 4B is a schematic diagram illustrating the second example of adjusting a set temperature with the touch panel according to the first embodiment.

[FIG. 4C]

FIG. 4C is a schematic diagram illustrating the second example of adjusting a set temperature with the touch panel according to the first embodiment.

[FIG. 5]

FIG. 5 is a flowchart illustrating operations of the touch panel according to the first embodiment.

[FIG. 6A]

FIG. 6A is a schematic diagram illustrating a touch panel according to a second embodiment, viewed from an operating surface side thereof.

[FIG. 6B]

FIG. 6B is a schematic diagram illustrating a touch panel according to a third embodiment, viewed from an operating surface side thereof.

[FIG. 6C]

FIG. 6C is a schematic diagram illustrating a touch panel according to a fourth embodiment, viewed from an operating surface side thereof.

[FIG. 7A]

FIG. 7A is a schematic diagram illustrating a touch panel according to a fifth embodiment, viewed from an operating surface side thereof.

[FIG. 7B]

FIG. 7B is a block diagram illustrating an air conditioning device according to a sixth embodiment.

### DESCRIPTION OF EMBODIMENTS

### Overview of Embodiments

An operation input device according to embodiments includes: an operation detection unit that detects an operation that has been made, and that has a plurality of operation regions to which, of functions executed by a controlled device, the same type of functions are assigned; and a controller that determines one of the plurality of operation regions in which an operation has been detected by the operation detection unit to be a master operation region and the other of the operation regions to be a slave operation region, and outputs, to the controlled device, control information for controlling a state of the function assigned to the slave operation region to match a state of the function assigned to the master operation region.

This operation input device outputs, to the controlled device, the control information for controlling the state of a function assigned to the slave operation region to match the state of a function assigned to the master operation region, which allows the states of the same type of functions to be matched easily and improves the operability as compared to a case where the states of the assigned functions are matched through separate operations.

### First Embodiment

### Configuration of Touch Panel 1

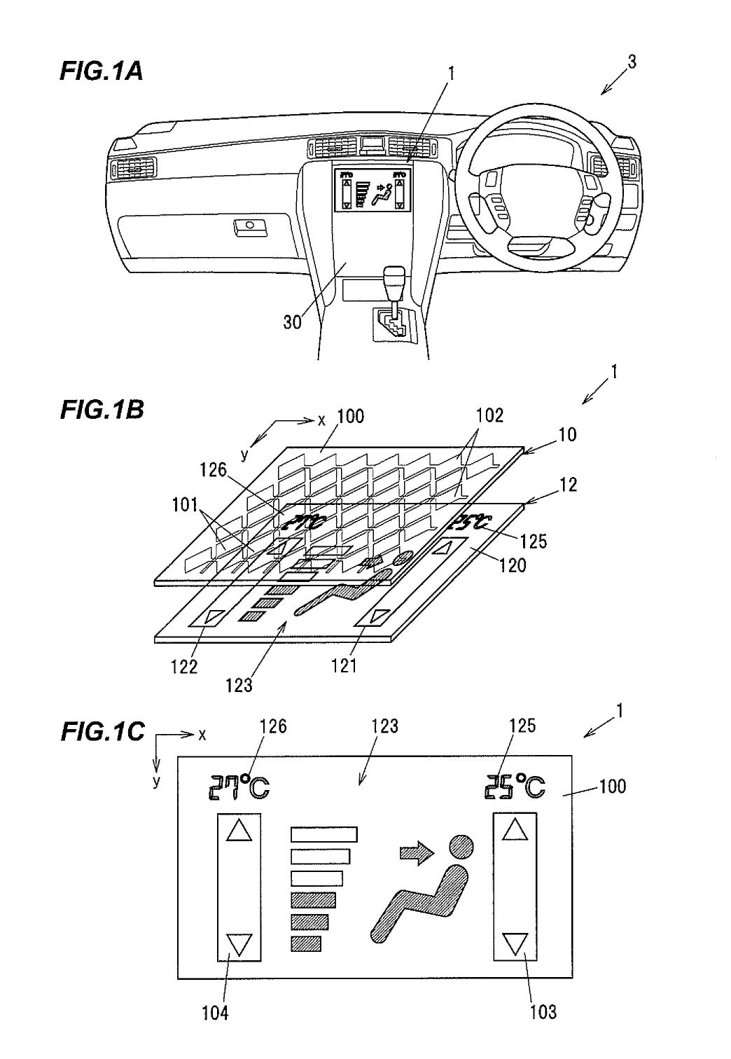

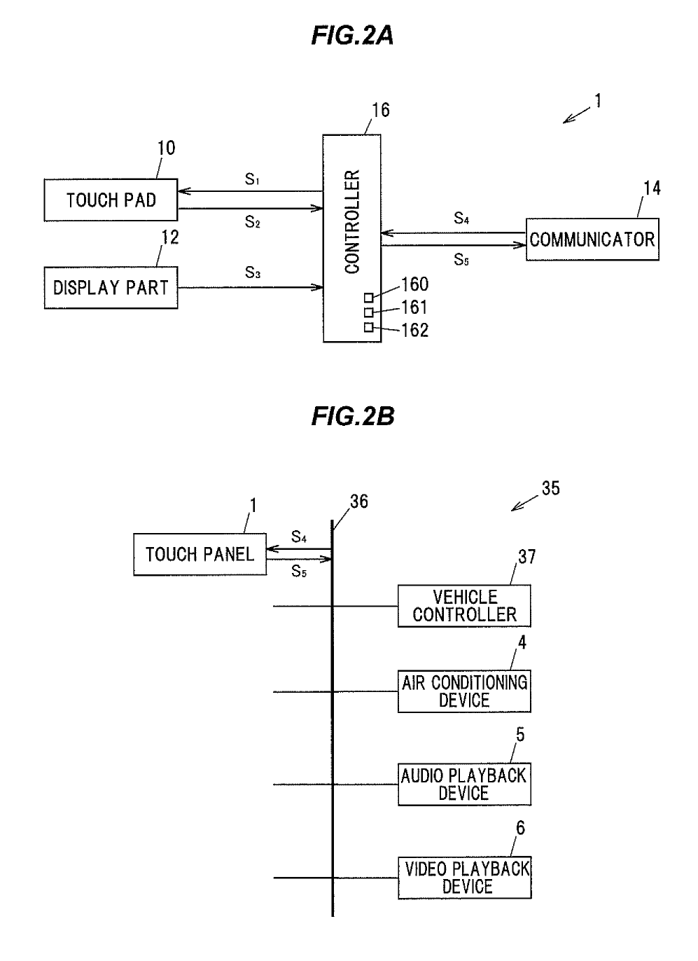

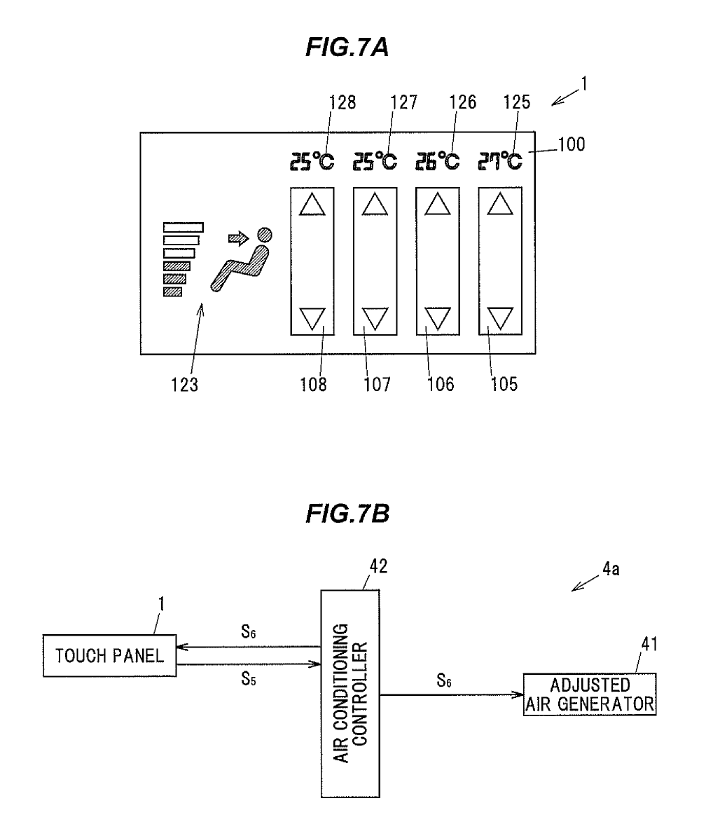

FIG. 1A is a schematic diagram illustrating the interior of a vehicle in which a touch panel according to a first embodiment is installed, FIG. 1B is an exploded perspective view of the touch panel, and FIG. 1C is a schematic diagram illustrating the touch panel viewed from an operating surface side thereof. FIG. 2A is a block diagram illustrating the touch panel according to the first embodiment, and FIG. 2B is a block diagram illustrating a vehicle communication system to which the touch panel is electromagnetically connected. In the drawings associated with the following embodiments, ratios between elements in the drawings may be different from the actual ratios. In addition, in FIGS. 2A, 2B, and FIG. 7B, which will be described later, arrows indicate the flows of primary signals, information, and the like.

A touch panel 1 serving as an operation input device is, as illustrated in FIG. 1A, installed in a center console 30 located between a driver's seat and a passenger's seat of a vehicle 3, for example. As illustrated in FIG. 19, the touch panel 1 includes a touch pad 10 disposed on top of a display part 12. However, the touch panel 1 is not limited to a configuration in which the touch pad 10 is disposed on top of the display part 12, and the two elements may be disposed separate from each other.

As illustrated in FIG. 2B, the touch panel 1 is configured to display a display image 120 based on display image information S₄ obtained from an air conditioning device 4 that delivers temperature-controlled air to the interior of the vehicle 3, an audio playback device 5 that plays back audio data recorded in a recording medium, a video playback device 6 that plays back video data recorded in a recording medium, and the like, which serve as electronic devices installed in the vehicle 3. The touch panel 1 is further configured to detect operations made on an operating surface 100 of the touch pad 10. The display image 120 is displayed through the touch pad 10.

As illustrated in FIGS. 1C and 2A, the touch panel 1 includes the touch pad 10 and a controller 16. The touch pad 10, serving as an operation detection unit, detects operations that have been made, and has a first operation region 103 and a second operation region 104 to which, of functions executed by a controlled device, the same type of functions are assigned. The controller 16 determines one of the first operation region 103 and the second operation region 104 in which an operation has been detected by the touch pad 10 to be a master operation region and the other of the operation regions to be a slave operation region, and outputs, to the controlled device, control information S₅ for controlling a state of the function assigned to the slave operation region to match a state of the function assigned to the master operation region.

Here, examples of the controlled device according to the present embodiment include the air conditioning device 4. “The same type of function” executed by the controlled device refers to, for example, a function for setting the temperature of air delivered by the air conditioning device 4 to the interior of the vehicle 3. In addition, in the case where the air conditioning device 4 is capable of, for example, setting the airflow rate of the air being delivered for the driver's seat and the passenger's seat, “the same type of function” refers to a function for setting the airflow rate.

“The state of the function assigned” refers, in the case where the assigned function is a function for setting the set temperature, to the set temperature that has been set. In other words, the touch panel 1 is configured to output, to the air conditioning device 4, the control information S₅ for matching the set temperature set in the slave operation region to the set temperature set in the master operation region.

As a variation, in the case where the controlled devices are the audio playback device 5 and the video playback device 6, “the same type of function” refers to a function for setting volume, tone, or the like of speakers for the driver's seat and the passenger's seat, for example.

### Configuration of Touch Pad 10

The touch pad 10 is a touch sensor that detects a touched position on the operating surface 100 when the operating surface 100 is touched by a part of the operator's body (a finger, for example) or with a dedicated pen, for example. The operator can, tor example, operate the connected air conditioning device 4 by operating the operating surface 100.

For example, the touch pad 10 according to the present embodiment is an electrostatic capacitance-type touch sensor that detects changes in current produced when a finger approaches the operating surface 100, the changes in current being in inverse proportion to a distance between an electrode and the finger. The touch pad 10 is also a mutual capacitance-type touch sensor capable of detecting operations made on the operating surface 100 by multiple fingers, or in other words, the touch sensor is capable of multi-touch detection.

As illustrated in FIG. 1B, in the touch pad 10, xy coordinates are set for the operating surface 100. The xy coordinates are orthogonal coordinates, and an origin thereof is at the upper left of the operating surface 100 in the drawing indicated in FIG. 1C, for example.

The touch pad 10 includes a plurality of first electrodes 101 serving as driving electrodes provided below the operating surface 100, and a plurality of second electrodes 102 serving as receiving electrodes. The first electrodes 101 and the second electrodes 102 are transparent electrodes formed of an indium tin oxide (ITO), for example.

The first electrodes 101 are arranged at equal intervals so as to be orthogonal to the x axis indicated in FIG. 1B. The second electrodes 102 are arranged at equal intervals so as to be orthogonal to the y axis. The first electrodes 101 and the second electrodes 102 have shapes in which a plurality of electrodes having rectangular shapes are connected to each other.

As illustrated in FIG. 1B, the touch pad 10 includes six first electrodes 101 and four second electrodes 102. However, the number of first electrodes 101 and second electrodes 102 can be set as desired according to the specification of the touch pad 10.

The touch pad 10 is electromagnetically connected to the controller 16. The touch pad 10 is configured so that the first electrodes 101 are driven in response to a driving signal S₁ outputted from the controller 16 and electrostatic capacitances are read out via the second electrodes 102. The read-out electrostatic capacitances are outputted to the controller 16 as detection information S₂.

Note that “electromagnetically connected” described above refers to a connection using at least one of a connection by a conductor, a connection by light, which is a type of electromagnetic wave, and a connection by radio waves, which are a type of electromagnetic wave.

### Configuration of Display Part 12

The display part 12 includes a liquid-crystal display, for example. The display part 12 is electrically connected to the controller 16. The display part 12 is configured to display the display image 120 on the basis of display control information S₃ obtained from the controller 16.

As illustrated in FIG. 1B, a first display region 121, a second display region 122, a third display region 123, a first temperature display region 125, and a second temperature display region 126, for example, are displayed in the display part 12.

The first display region 121 is a longitudinal region displayed on the right side (the driver's seat side) of the display image 120 in the drawing indicated in FIG. 1B. The first display region 121 is, for example, a region that displays the set temperature of the temperature-controlled air delivered from an air outlet on the driver's seat side. The first display region 121 is assigned a function for increasing the set temperature when a tracing operation in the upward direction of the drawing indicated in FIG. 1C is made on a region of the operating surface 100 where the first display region 121 is projected and for decreasing the set temperature when a tracing operation in the downward direction is made. This region corresponds to the first operation region 103 illustrated in FIG. 1C.

The second display region 122 is a longitudinal region displayed on the left side (the passenger's seat side) of the display image 120 in the drawing indicated in FIG. 1B. The second display region 122 is, for example, a region that displays the set temperature of the temperature-controlled air delivered from an air outlet on the passenger's seat side. The second display region 122 is assigned a function for increasing the set temperature when a tracing operation in the upward direction of the drawing indicated in FIG. 1C is made on the region of the operating surface 100 where the second display region 122 is projected and for decreasing the set temperature when a tracing operation in the downward direction is made. This region corresponds to the second operation region 104 illustrated in FIG. 1C.

In other words, the operator operates the first operation region 103 in order to adjust the set temperature on the driver's seat side and operates the second operation region 104 in order to adjust the set temperature on the passenger's seat side.

Note that in the drawings viewing the touch panel 1 from the operating surface 100 side, the first display region 121 and second display region 122 projected on the touch pad 10 correspond to the first operation region 103 and second operation region 104 to be operated in order to execute the respective functions assigned to the first display region 121 and the second display region 122, and thus only the operation regions are illustrated. The third display region 123, the first temperature display region 125, and the second temperature display region 126 are assumed to be viewed by the operator through the touch pad 10, and are thus given the same names and reference numerals as in FIG. 1B.

The third display region 123 is a region that displays the current airflow rate of the air conditioning device 4 and which air outlet of the vehicle 3 the temperature-controlled air is being blown from. The operator can adjust the airflow rates on the driver' seat side and the passenger's seat side after touching the image indicating the airflow rate, for example. As with the set temperature, the touch panel 1, with the first operation region 103 and the second operation region 104 defined as a master operation region and a slave operation region, respectively, can output the control information S₅ for matching the airflow rate of the slave operation region to the airflow rate of the master operation region.

The first temperature display region 125 is a region that displays the set temperature of the air delivered from the air outlet on the driver's seat side. The second temperature display region 126 is a region that displays the set temperature of the air delivered from the air outlet on the passenger's seat side.

### Configuration of Communicator 14

A communicator 14 is electrically connected to the controller 16, and is electromagnetically connected to a vehicle local area network (LAN) 36 of a vehicle communication system 35.

The communicator 14 is configured to obtain the display image information S₄ from the controlled device via the vehicle LAN 36 and output the control information S₅ obtained from the controller 16 to the controlled device via the vehicle LAN 36.

### Configuration of Controller 16

The controller 16 is, for example, a microcomputer including a central processing unit (CPU) that carries out computations, processes, and the like on obtained data in accordance with a stored program; a random access memory (RAM) and a read only memory (ROM) that are semiconductor memories; and the like. A program for operations of the controller 16, for example, is stored in the ROM. The RAM is used as a storage region that temporarily stores computation results and the like, for example.

As illustrated in FIG. 2A, the controller 16 includes a threshold 160, accumulated information 161, and image information 162.

The controller 16 is configured to compare the detection information S₂ obtained from the touch pad 10 with the threshold 160 and calculate coordinates at which a finger has been detected on the basis of a result of the comparison.

The controller 16 is configured to store the coordinates at which the finger has been detected along with the time of detection as the accumulated information 161.

The controller 16 is configured to store the image information 162 associated with the display image 120 displayed in the display part 12 on the basis of the display image information S₄ obtained through the communicator 14. The controller 16 is configured to determine operation regions and determine which operation region has the coordinates at which the operating finger has been detected on the basis of the image information 162.

The controller 16 is also configured to generate the control information S₅ for causing the air conditioning device 4 to execute functions, and to output the control information S₅ to the air conditioning device 4 through the communicator 14.

The controller 16 is configured to determine which of the first display region 121 and the second display region 122 is the master operation region and which is the slave operation region on the basis of the detection information S₂. The controller 16 is configured to set one of the first operation region 103 and the second operation region 104 in which the first operation is detected as the master operation region.

### Configuration of Vehicle Communication System 35

As illustrated in FIG. 2B, the vehicle communication system 35 includes the vehicle LAN 36, a vehicle controller 37, and the electronic devices installed in the vehicle. Examples of the electronic devices include the air conditioning device 4, the audio playback device 5, and the video playback device 6.

The vehicle controller 37 is a microcomputer including a CPU, a RAM, a ROM, and the like. The vehicle controller 37 controls the vehicle LAN 36.

### Example of Adjusting Set Temperature

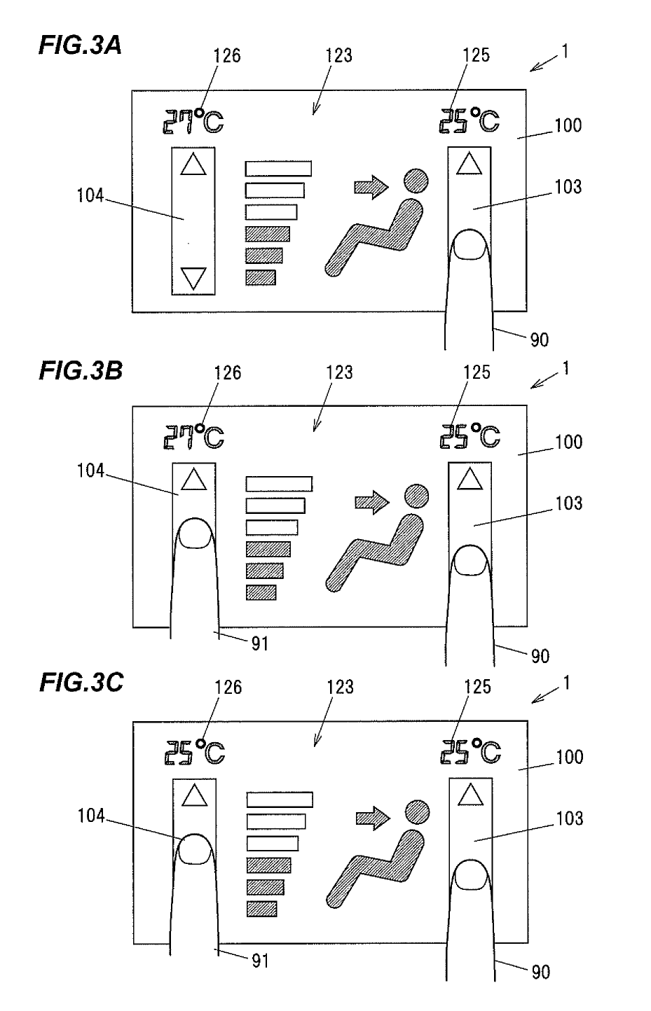

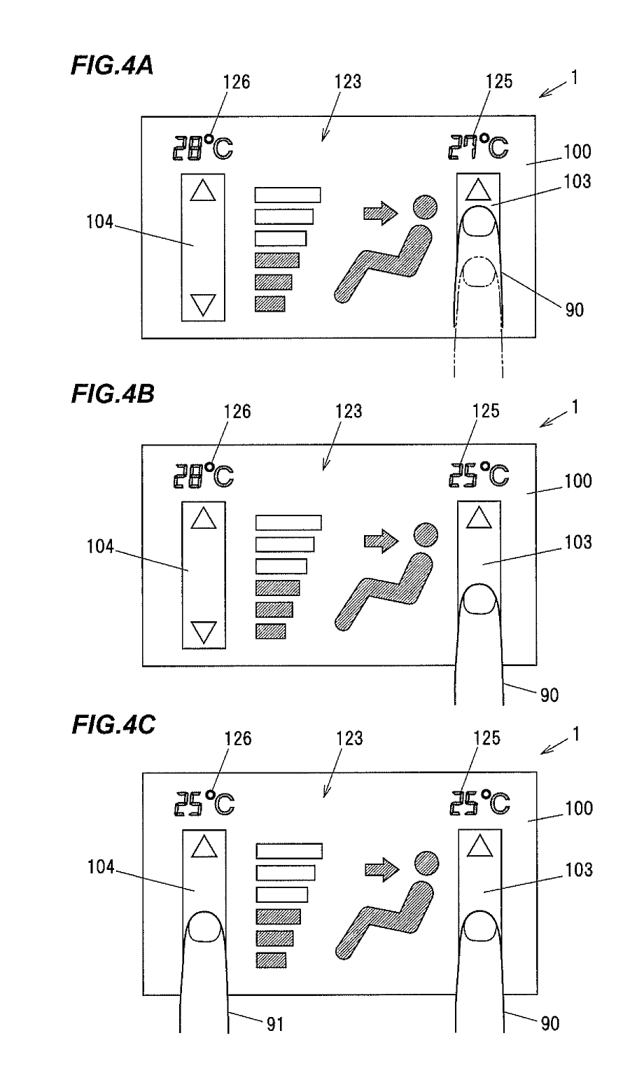

FIGS. 3A to 3C are schematic diagrams illustrating a first example of adjusting the set temperature with the touch panel according to the first embodiment. FIGS. 4A to 4C are schematic diagrams illustrating a second example of adjusting the set temperature with the touch panel according to the first embodiment. The following will describe an example in which the operator adjusts the set temperature on the passenger's seat side to match the set temperature on the driver's seat side.

### First Adjustment Example

As illustrated in FIG. 3A, the set temperature on the driver's seat side is “25° C.” and the set temperature on the passenger's seat side is “27° C.”. In the case where the operator wishes to match the set temperature on the driver's seat side to the set temperature on the passenger's seat side, the operator uses an operating finger 90 to touch the first operation region 103, through which the set temperature on the driver's seat side can be adjusted. The first operation region 103 on the driver's seat side becomes the master operation region as a result of this touch operation. Note that the touch operation is an operation in which the operating finger is brought into contact with a region to be detected.

Next, as illustrated in FIG. 3B, the operator uses an operating finger 91 to touch the second operation region 104, through which the set temperature on the passenger's seat side can be adjusted, while continuing to touch the first operation region 103. As a result of this touch operation, the controller 16 determines that multiple operation regions have been operated and that the second operation region 104 on the passenger's seat side is the slave operation region.

As illustrated in FIG. 3C, the set temperature on the passenger's seat side is set to the set temperature on the driver's seat side, namely “25° C.”, as a result of the operations indicated in FIGS. 3A and 3B.

Note that in the case where the operator wishes to set the set temperature on the driver's seat side to the set temperature on the passenger's seat side, the operator may touch the second operation region 104 and then touch the first operation region 103 while continuing to touch the second operation region 104.

### Second Adjustment Example

As illustrated in FIG. 4A, the set temperature on the driver's seat side is “27° C.” and the set temperature on the passenger's seat side is “28° C.”. In the case where the operator wishes to adjust the set temperature on the driver's seat side and then match the adjusted set temperature on the driver's seat side to the set temperature on the passenger's seat side, the operator first uses the operating finger 90 to make a tracing operation on the first operation region 103.

The operator's desired set temperature is “25° C.”, and thus the operator makes a tracing operation on the first operation region 103 in the downward direction of the drawing indicated in FIG. 4A. The tracing operation is an operation in which the operating finger is moved while in contact with the region in which the operation is detected.

As illustrated in FIG. 4B, the operator stops the tracing operation upon the set temperature on the driver's seat side reaching the desired set temperature of “25° C.”. Then, as illustrated in FIG. 4C, the operator uses the operating finger 91 to touch the second operation region 104 while keeping the operating finger 90 in contact with the first operation region 103.

As illustrated in FIG. 4C, the set temperature on the passenger's seat side is adjusted to the set temperature on the driver's seat side, namely “25° C.”, as a result of the second operation region 104 being touched in this manner.

Note that in the case where the operator wishes to match the set temperature on the driver's seat side to the set temperature on the passenger's seat side, the operator may adjust the set temperature on the passenger's seat side to the desired set temperature by making a tracing operation on the second operation region 104, and then touch the first operation region 103 while maintaining contact with the second operation region 104.

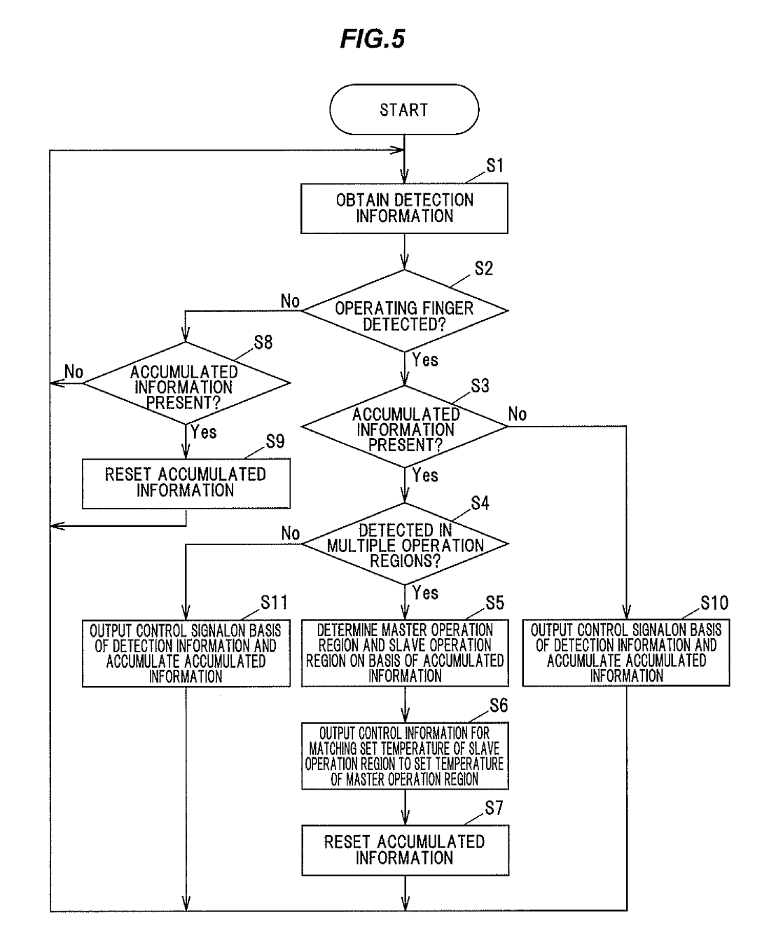

Operations of the touch panel 1 according to the present embodiment will be described hereinafter according to the flowchart illustrated in FIG. 5, with reference to the other drawings as well.

### Operation

After the power of the vehicle 3 is turned on, the controller 16 of the touch panel 1 generates the driving signal S₁ and outputs the driving signal S₁ to the touch pad 10, and periodically obtains the detection information S₂ (S1).

The controller 16 compares the obtained detection information S2 with the threshold 160 to determine whether or not an operating finger has been detected. Upon the operating finger being detected (Yes in S2), the controller 16 determines whether or not an operating finger was detected in a previous period on the basis of the accumulated information 161.

In the case where there is accumulated information 161 (Yes in S3), the controller 16 determines whether or not the detected operating fingers span multiple operation regions.

In the case where operating fingers have been detected across multiple operation regions (Yes in S4), the controller 16 determines the master operation region and the slave operation region on the basis of the accumulated information 161 (S5). For example, in the case where the operations indicated in FIGS. 3A to 3C have been made, the controller 16 determines that the first operation region 103 is the master operation region and the second operation region 104 is the slave operation region.

After determining the master operation region and the slave operation region, the controller 16 generates the control information S₅ so as to match the set temperature of the slave operation region to the set temperature of the master operation region, outputs the control information S₅ to the vehicle communication system 35 via the communicator 14 (S6), and resets the accumulated information 161 (S7).

Upon obtaining the control information S₅ via the vehicle LAN 36, the air conditioning device 4 matches the set temperature of the slave operation region to the set temperature of the master operation region. For example, as illustrated in FIGS. 3A to 3C, the air conditioning device 4 matches the set temperature of the second operation region 104 serving as the slave operation region, namely “27° C.”, to the set temperature of the first operation region 103 serving as the master operation region, namely “25° C.”.

The controller 16 returns to step 1 and obtains the detection information S₂.

In the case where an operating finger has not been detected in step 2 (No in S2), the controller 16 confirms whether or not there is accumulated information 161. In the case where there is accumulated information 161 (Yes in S8), the controller 16 resets the accumulated information 161 (S9), returns to step 1, and obtains the detection information S₂. In the case where there is no accumulated information 161 (No in S8), the controller 16 returns to step 1 and obtains the detection information S₂.

In the case where an operating finger has been detected but there is no accumulated information 161 in step 3 (No in S3), the controller 16 generates the control information S₅ on the basis of the detection information S₂, outputs the control information S₅ to the vehicle communication system 35 through the communicator 14, and accumulates information including the coordinates at which the operating finger was detected as the accumulated information 161 (S10).

In the case where an operating finger has been detected and there is accumulated information 161 but the operation does not span multiple operation regions in step 4 (No in S4), the controller 16 generates the control information S₅ on the basis of the detection information S₂, outputs the control information S₅ to the vehicle communication system 35 through the communicator 14, and accumulates information including the coordinates at which the operating finger was detected as the accumulated information 161 (S11).

The controller 16 continually executes this series of processes until the power is turned off

### Effect of Embodiment

The touch panel 1 according to the present embodiment can improve operability. Specifically, the touch panel 1 can determine the master operation region and the slave operation region on the basis of an operation that has been made and then match the set temperature set in the slave operation region to the set temperature set in the master operation region, making it possible to easily match the states of the same type of functions and improve the operability as compared to a case where a desired set temperature is set while adjusting both operation regions.

Additionally, the touch panel 1 can easily match the states of the same type of functions, which reduces the operating burden.

Furthermore, the touch panel 1 can match the states of the same type of functions by dividing the multiple operation regions in which operations have been detected into the master operation region and the slave operation region, which makes operations easy and reduces the operating burden as compared to a case where the master operation region is designated using a provided switch.

### Second Embodiment

A second embodiment differs from the above-described embodiment in that the first operation region 103 and the second operation region 104 are arranged horizontally.

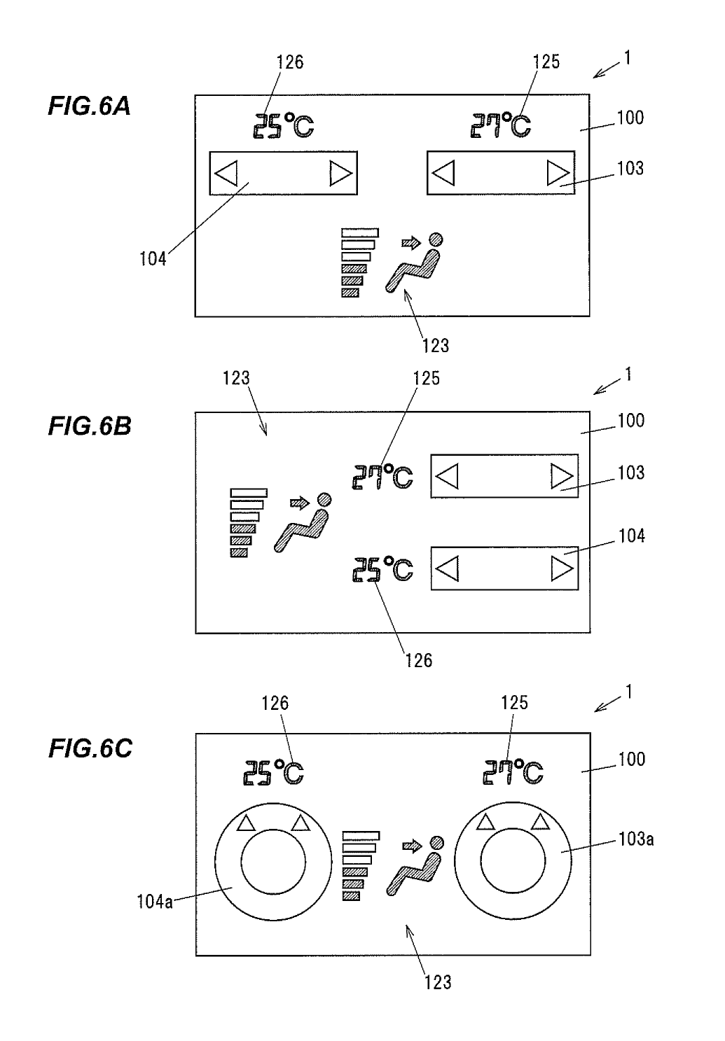

FIG. 6A is a schematic diagram illustrating a touch panel according to the second embodiment, viewed from an operating surface side thereof. In the embodiments described below, parts having the same functions and configurations as in the first embodiment will be given the same reference numerals as in the first embodiment, and descriptions thereof will be omitted.

As illustrated in FIG. 6A, in the touch panel 1 according to the present embodiment, the first operation region 103 and the second operation region 104 are arranged in a single row in the horizontal direction.

This touch panel 1 is configured to output the control information S₅ so that the set temperature increases when the right sides of the first operation region 103 and the second operation region 104 in the drawing indicated in FIG. 6A are operated and the set temperature decreases when the left sides are operated.

With the first operation region 103 and the second operation region 104 indicated in FIG. 6A defined as the master operation region and the slave operation region, respectively, on the basis of an operation that has been made, the controller 16 outputs the control information S₅ so that the set temperature of the slave operation region matches the set temperature of the master operation region.

### Third Embodiment

A third embodiment differs from the above-described embodiments in that the first operation region 103 and the second operation region 104 are arranged in a single row vertically.

FIG. 6B is a schematic diagram illustrating a touch panel according to the third embodiment, viewed from an operating surface side thereof.

As illustrated in FIG. 6B, in the touch panel 1 according to the present embodiment, the first operation region 103 and the second operation region 104 are arranged in a single row in the vertical direction.

With the first operation region 103 and the second operation region 104 indicated in FIG. 6B defined as the master operation region and the slave operation region, respectively, on the basis of an operation that has been made, the controller 16 outputs the control information S₅ so that the set temperature of the slave operation region matches the set temperature of the master operation region.

### Fourth Embodiment

In a fourth embodiment, the shapes of the first operation region and the second operation region are different from the shapes of the first operation region and the second operation region in the above-described embodiments.

FIG. 6C is a schematic diagram illustrating a touch panel according to the fourth embodiment, viewed from an operating surface side thereof.

A first operation region 103a and a second operation region 104a have donut shapes. The touch panel 1 is configured to output the control information S₅ so that the set temperature increases when a clockwise tracing operation in the drawing indicated in FIG. 6C is made on the first operation region 103a and. the second operation region 104a and the set temperature decreases when a counter-clockwise tracing operation is made.

With the first operation region 103a and the second operation region 104a indicated in FIG. 6C defined as the master operation region and the slave operation region, respectively, on the basis of an operation that has been made, the controller 16 outputs the control information S₅ so that the set temperature of the slave operation region matches the set temperature of the master operation region.

Note that the shapes of the first operation region 103a and the second operation region 104a according to the present embodiment are not limited to donut shapes, and may be different shapes, such as ovals, according to the specification of the connected electronic device.

### Fifth Embodiment

A fifth embodiment differs from the above-described embodiments in that there are four operation regions.

FIG. 7A is a schematic diagram illustrating a touch panel according to the fifth embodiment, viewed from an operating surface side thereof.

The touch panel 1 according to the present embodiment includes a first operation region 105 to a fourth operation region 108. The first operation region 105 is, for example, a region that can adjust the set temperature of air delivered from an air outlet on the driver's seat side. The second operation region 106 is, for example, a region that can adjust the set temperature of air delivered from an air outlet on the passenger's seat side. The third operation region 107 is, for example, a region that can adjust the set temperature of air delivered from an air outlet for the driver's seat side rear seat. The fourth operation region 108 is, for example, a region that can adjust the set temperature of air delivered from an air outlet for the passenger's seat side rear seat.

A first temperature display region 125 to a fourth temperature display region 128 that display set temperatures are arranged above the first operation region 105 to the fourth operation region 108.

For example, in the case where the operator wishes to match the set temperature of the second operation region 106, namely “26° C.”, the set temperature of the third operation region 107, namely “25° C.”, and the set temperature of the fourth operation region 108, namely “25° C.”, to the set temperature of the first operation region 105, namely “27° C.”, the operator first touches the first operation region 105, and then touches the second operation region 106 to the fourth operation region 108 while continuing to touch the first operation region 105.

The controller 16 determines the first operation region 105 to be the master operation region and the second operation region 106 to the fourth operation region 108 to be slave operation regions on the basis of the detection information S₂ and the accumulated information 161, and generates and outputs the control information S₅ so that the set temperatures of the slave operation regions match the set temperature of the slave operation region.

Additionally, for example, in the case where the operator wishes to match the set temperature of the second operation region 106, namely “26° C.”, and the set temperature of the third operation region 107, namely “25° C.”, to the set temperature of the first operation region 105, namely “27° C.”, the operator first touches the first operation region 105, and then touches the second operation region 106 and the third operation region 107 while continuing to touch the first operation region 105.

The controller 16 determines the first operation region 105 to be the master operation region and the second operation region 106 and the third operation region 107 to be slave operation regions on the basis of the detection information S₂ and the accumulated information 161, and generates and outputs the control information S₅ so that the set temperature of the slave operation regions matches the set temperature of the slave operation region.

Note that the number of operation regions is not limited to the numbers indicated in the above-described embodiments, and any desired number operation regions may be provided according to the specification of the connected electronic device.

### Sixth Embodiment

A sixth embodiment relates to an air conditioning device including the above-described touch panel 1.

FIG. 7B is a block diagram illustrating an air conditioning device according to the sixth embodiment. This air conditioning device 4a includes the touch panel 1, and is configured to deliver temperature-controlled air to the interior of the vehicle 3. The air conditioning device 4a includes an adjusted air generator 41 and an air conditioning controller 42, as illustrated in FIG. 7B.

As in the above-described embodiments, the touch panel 1 is configured to determine, in the case where operations have been made in multiple operation regions, a master operation region and a slave operation region, generate the control information S₅ on the basis of a result of the determination so that the state of a function assigned to the slave operation region matches the state of a function assigned to the master operation region, and output the control information S₅ to the air conditioning controller 42.

The adjusted air generator 41 is configured to, for example, adjust the temperature of air to the set temperature and adjust an airflow rate on the basis of air conditioning control information S₆, and deliver the air from a designated air outlet.

The air conditioning controller 42 is, for example, a microcomputer including a CPU that carries out computations, processes, and the like on obtained data in accordance with a stored program, a RAM and a ROM that are semiconductor memories, and the like.

The air conditioning controller 42 is configured to generate the air conditioning control information S₆ for controlling the adjusted air generator 41 on the basis of the obtained control information S₅ and output the control information S₆ to the adjusted air generator 41.

According to the touch panel 1 of at least one of the embodiments described above, the operability can be improved.

Although several embodiments of the present invention and modifications thereof have been described above, these embodiments and modifications are merely examples, and the invention according to claims is not intended to be limited thereto. Such novel embodiments and modifications can be implemented in various other forms, and various omissions, substitutions, changes, and the like can be made without departing from the spirit and scope of the present invention. In addition, all combinations of the features described in these embodiments and modifications are not necessary to solve the problem. Furthermore, these embodiments and modifications are included within the spirit and scope of the invention and also within the scope of the invention described in the claims and equivalents thereof.

### INDUSTRIAL APPLICABILITY

The present invention can be applied to operation input devices for operating in-vehicle devices such as air conditioning devices, and audio devices.

### REFERENCE SIGNS LIST

1 TOUCH PANEL

3 VEHICLE

4 AIR CONDITIONING DEVICE

4a AIR CONDITIONING DEVICE

5 AUDIO PLAYBACK DEVICE

6 VIDEO PLAYBACK DEVICE

10 TOUCH PAD

12 DISPLAY PART

14 COMMUNICATOR

16 CONTROLLER

30 CENTER CONSOLE

35 VEHICLE COMMUNICATION SYSTEM

36 VEHICLE LAN

37 VEHICLE CONTROLLER

41 ADJUSTED AIR GENERATOR

42 AIR CONDITIONING CONTROLLER

90 OPERATING FINGER

91 OPERATING FINGER

100 OPERATING SURFACE

101 FIRST ELECTRODE

102 SECOND ELECTRODE

103 FIRST OPERATION REGION

103a FIRST OPERATION REGION

104 SECOND OPERATION REGION

104a SECOND OPERATION REGION

105 FIRST OPERATION REGION

106 SECOND OPERATION REGION

107 THIRD OPERATION REGION

108 FOURTH OPERATION REGION

120 DISPLAY IMAGE

121 FIRST DISPLAY REGION

122 SECOND DISPLAY REGION

123 THIRD DISPLAY REGION

125 FIRST TEMPERATURE DISPLAY REGION

126 SECOND TEMPERATURE DISPLAY REGION

127 THIRD TEMPERATURE DISPLAY REGION

128 FOURTH TEMPERATURE DISPLAY REGION

160 THRESHOLD

161 ACCUMULATED INFORMATION

162 IMAGE INFORMATION

1. An operation input device, comprising:
an operation detection unit that detects an operation that has been made, the operation detection unit having a plurality of operation regions to which, of functions executed by a controlled device, a same type of functions are assigned; and
a controller that determines one of the plurality of operation regions in which an operation has been detected by the operation detection unit to be a master operation region and the other of the operation regions to be a slave operation region, and outputs, to the controlled device, control information for controlling such that a state of the function assigned to the slave operation region is matched to a state of the function assigned to the master operation region.

2. The device according to claim 1, wherein the controller determines an operation region, of the plurality of operation regions, in which a first operation is detected to be the master operation region.

3. An air conditioning device, comprising the operation input device according to claim 1, wherein the air conditioning device is configured to deliver temperature-controlled air to an interior of a vehicle.

4. The device according to claim 1, wherein the operation detection unit comprises a touch panel attached to or disposed in a vehicle.

5. The device according to claim 4, wherein the touch panel comprises a display part that displays the plurality of operation regions.

6. The device according to claim 1, wherein the states of the functions each includes a control value used to control the controlled device.

7. The device according to claim 1, wherein when, within a set amount of time after a first operation is detected in a first operation region of the plurality of operation regions, an operation is detected with respect to a second operation region that is different from the first operation region, the controller determines the first operation region to be the master operation region and the second operation region to be the slave operation region.

8. The device according to claim 7, wherein when, within a set amount of time after a first operation is detected in a first operation region of the plurality of operation regions, no operation is detected with respect to a second operation region that is different from the first operation region, the controller does not determine the master operation region and the slave operation region.

9. The device according to claim 1, wherein while a first operation is continuously detected in a first operation region of the plurality of operation regions, when an operation is detected with respect to a second operation region that is different from the first operation region, the controller determines the first operation region to be the master operation region and the second operation region to be the slave operation region.

10. The device according to claim 9, wherein while a first operation is continuously detected in a first operation region of the plurality of operation regions, when no operation is detected with respect to a second operation region that is different from the first operation region, the controller does not determine the master operation region and the slave operation region.
